(19) United States
(12) Patent Application Publication
(10) Pub. No.: US 2014/0357761 A1
(43) Pub. Date: Dec. 4, 2014

(54) CARBON FIBER TUBULE ROD REINFORCED CONCRETE

(71) Applicant: James Kelly Williamson, Tuscaloosa, AL (US)

(72) Inventor: James Kelly Williamson, Tuscaloosa, AL (US)

(21) Appl. No.: 14/296,227

(22) Filed: Jun. 4, 2014

Related U.S. Application Data
(60) Provisional application No. 61/830,704, filed on Jun. 4, 2013.

(51) Int. Cl. C04B 14/38

(52) U.S. Cl. CPC C04B 14/386
USPC 523/215; 428/34.1; 428/36.91; 106/814

(57) ABSTRACT

A carbon fiber tubule rod reinforced concrete. Carbon fiber tubule rods may have an outer surface, an interior wall, an interior housing, a first end and a second end. An opening may be exposed on the first end and the second end of the carbon fiber tubule rod. At least one side hole may be exposed along the outer surface. The carbon fiber tubule rod may be made from braided carbon fiber tow, printed on a 3D carbon fiber printer, or the like. The carbon fiber tubule rod may have a corrugated shape. A resin coating may cover the carbon fiber tubule rod. A plurality of carbon fiber tubule rods may be mixed with concrete, so that while mixing in a high speed, shear-type mixer, it may enter the carbon fiber tubule rods and surround the carbon fiber tubule rods inside and out.

### CROSS-REFERENCE TO RELATED APPLICATION

This application claims the benefit of U.S. provisional application No. 61/830,704, filed Jun. 4, 2013, the contents of which are herein incorporated by reference.

### BACKGROUND OF THE INVENTION

The present invention relates to concrete and, more particularly, to reinforcing concrete through carbon fibers.

Basic concrete can manage pressure from around 10 MPa, 1450 psi, to 40 MPa, 5800 psi. Steel fiber has a pressure range between 750 and 2850 MPa. Carbon fiber is roughly ten times stronger than steel. Basic steel reinforced concrete has been used for nearly a century. It is outdated and is the major cause of present day infrastructure failure. Steel fiber is fairly new, but still is not close to the tensile strength of carbon fiber.

Corrosion of steel reinforcements in concrete is a common form of deterioration in cold climates and sea-side environments. Once the steel reinforcement is compromised the concrete is useless.

As can be seen, there is a need for a carbon fiber tubule reinforced concrete that increases strength of the overall product.

### SUMMARY OF THE INVENTION

In one aspect of the present invention, a carbon fiber tubule rod comprises an outer surface, an interior wall, an interior housing, a first end and a second end, wherein the first end and the second end each have an opening.

In another aspect of the present invention, a method for strengthening concrete comprises: making a plurality of carbon fiber tubule rods having an outer surface, an interior wall, an interior housing, a first end and a second end, wherein the first end and the second end each have an opening; mixing cement and water into a thick slurry; adding the plurality of carbon fiber tubule rods into the slurry;

and curing the concrete, wherein the concrete enters the plurality of carbon fiber tubule rods, surrounding the carbon fiber tubule rods inside and out.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use in an exemplary block of concrete;

FIG. 2 is a perspective view of an exemplary embodiment of the present invention;

FIG. 3 is a section view of an exemplary embodiment of the present invention, taken along line 3-3 in FIG. 2;

FIG. 4 is a section view of an exemplary embodiment of the present invention immersed in concrete; and

FIG. 5 is a flow chart of a mixing method of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a carbon fiber tubule rod reinforced concrete. Carbon fiber tubule rod may have an outer surface, an interior wall, an interior housing, a first end and a second end. An opening may be exposed on the first end and the second end of the carbon fiber tubule rod. At least one side hole may be exposed along the outer surface. The carbon fiber tubule rod may be made from braided carbon fiber tow, printed on a 3D carbon fiber printer, or the like. The carbon fiber tubule rod may have a corrugated shape. A resin coating may cover the outer surface and interior wall of the carbon fiber tubule rod. A plurality of carbon fiber tubule rods may be mixed with concrete, so that while the concrete is curing, it may enter the carbon fiber tubule rods and surround the carbon fiber tubule rods inside and out.

The process of carbonation in the curing of concrete lowers the pH of the cement pore solution and causes the reinforcement steel rebar or steel fibers to corrode, for reasons that each pH level below 7 pH is more acidic than the previous level. Using carbon fiber tubules instead may eliminate this particular problem and the curing process may not weaken the concrete. Carbon fiber may not be subject to such corrosive processes. Controlled temperatures and atmospheric humidity are still important to the curing process.

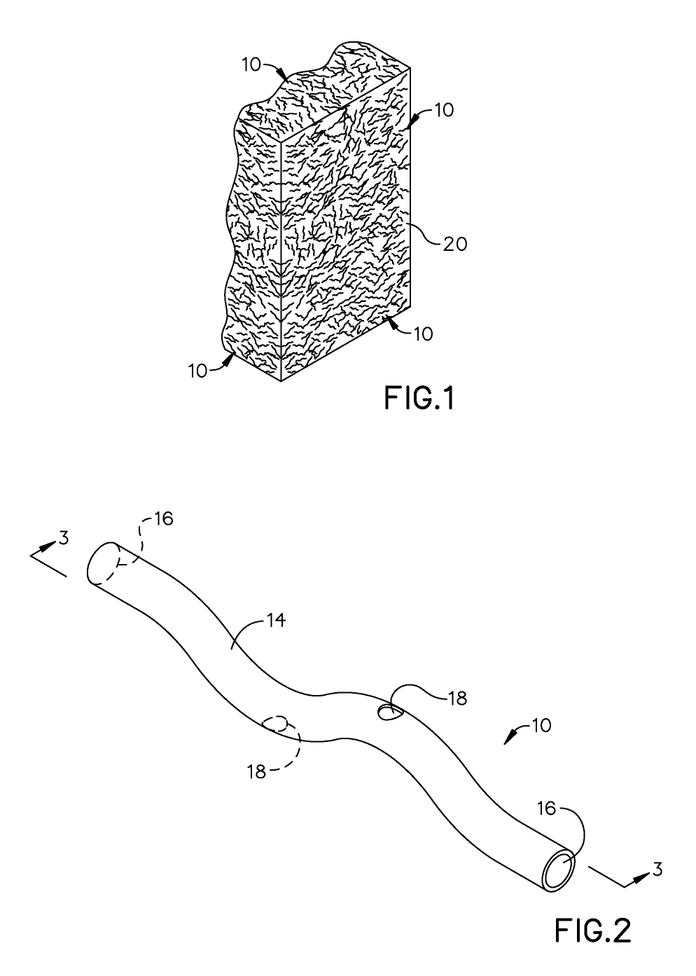

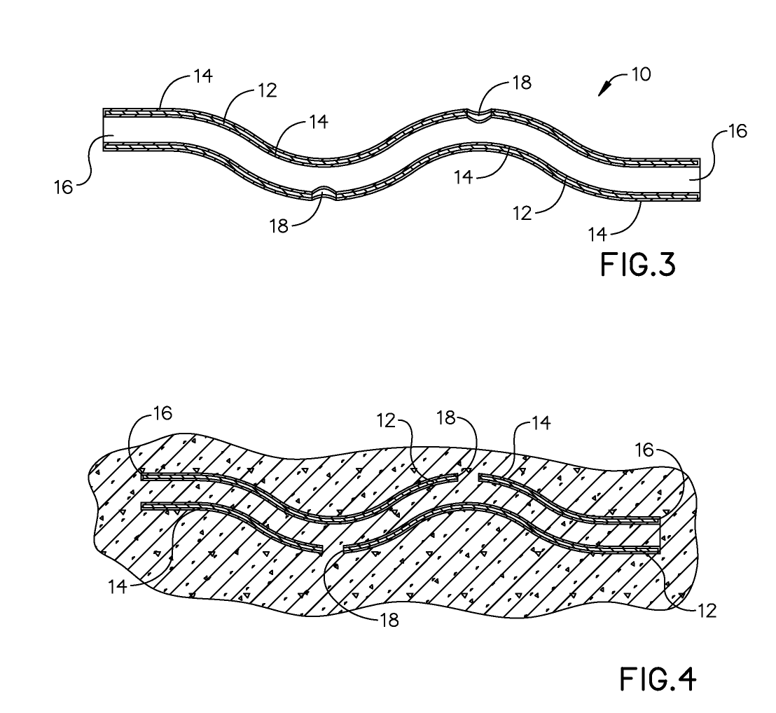

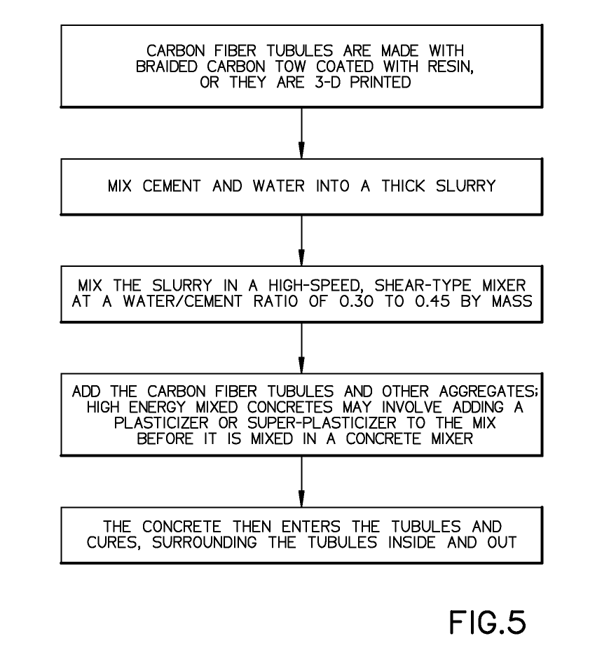

As is illustrated in FIGS. 1 through 5, the present invention may allow for the creation of carbon fiber tubule reinforced concrete. A plurality of carbon fiber tubule rods 10 may be created. Each carbon fiber tubule rod 10 may be made from carbon fiber tow 12. The carbon fiber tow 12 may be braided, printed on a 3D carbon fiber printer, or the like. Each carbon fiber tubule rod 10 may have an outside surface, an interior wall, an interior housing, a first end and a second end. The first end and the second end of the carbon fiber tubule rod 10 may each have an opening 16. In certain embodiments, at least one side hole 18 may be exposed along the surface of the carbon fiber tubule rod 10. In certain embodiments, the surface of the carbon fiber tubule rod 10 may be covered in a resin coating 14. The resin coating 14 may be along the outside surface and along the interior wall of the carbon fiber tubule rods 10. The carbon fiber tubule rods 10 may not be subject to corrosion. Adding the resin coating 14 may decrease the likelihood of any corrosion, and may give the carbon fiber tubule rods 10 rigidity. The plurality of carbon fiber tubule rods 10 may have a corrugated shape. The corrugated shape may allow for superior gripping strength so that there may be no stripping of the carbon fiber tubule rods 10 from the concrete when extreme force may be applied.

Mixing a plurality of carbon fiber tubule rods 10 with concrete 20 may create a tightly woven mesh that makes the combination much stronger than concrete alone. The carbon fiber tubule rod reinforced concrete may use a loose mesh of a plurality of rock aggregates, tubes, or the like, folded into the concrete mix to form a mass of reinforcement.

A method of making the carbon fiber tubule rod reinforced concrete may include the following steps. The cement 20 may be mixed with water into a thick slurry. The mixing of the slurry may be within a high speed, shear-type mixer. In certain embodiments, a water/cement ratio may be approximately 0.30 to approximately 0.45 by mass. Next, the carbon fiber tubules rods 10 may be added. High energy mixed concretes may involve adding a plasticizer or superplasticizer to the mixture before it is mixed in a concrete mixer. The concrete then may enter the carbon fiber tubule rods 10, surrounding the carbon fiber tubule rods 10 inside and out. Curing the concrete while it surrounds the carbon fiber tubule rods 10 may increase the tensile strength of the concrete mixture.

The present device may be used to strengthen military bunkers, highways, bridges, sea walls and levees, high rise structures for structural reasons, and may benefit those structures in hurricane, tornado, or earthquake prone regions. In certain embodiments, the present device may be used to create multiple prefabricated construction materials such as bridge trusses, piers and supports, highway divers and barriers, building slabs, prefabricated walls and roofing materials, military bunkers, barriers, bulkheads and the like.

It should be understood, of course, that the foregoing relates to exemplary embodiments of the invention and that modifications may be made without departing from the spirit and scope of the invention as set forth in the following claims.

What is claimed is:

1. A carbon fiber tubule rod comprising an outer surface, an interior wall, an interior housing, a first end and a second end, wherein the first end and the second end each have an opening.

2. The carbon fiber tubule rod of claim 1, wherein the carbon fiber tubule rod further comprises at least one side hole exposed along the outer surface.

3. The carbon fiber tubule rod of claim 1, wherein the carbon fiber tubule rod is made from braided carbon fiber tow.

4. The carbon fiber tubule rod of claim 1, wherein the carbon fiber tubule rod is printed on a 3-D carbon fiber printer.

5. The carbon fiber tubule rod of claim 1, wherein the carbon fiber tubule rod has a corrugated shape.

6. The carbon fiber tubule rod of claim 1, further comprising a resin coating covering the outer surface and interior wall of the carbon fiber tubule rod.

7. A method for strengthening concrete comprising:
making a plurality of carbon fiber tubule rods having an outer surface, an interior wall, an interior housing, a first end and a second end, wherein the first end and the second end each have an opening;
mixing cement and water into a thick slurry;
adding the plurality of carbon fiber tubule rods into the slurry; and
curing the concrete, wherein the concrete enters the plurality of carbon fiber tubule rods, surrounding the carbon fiber tubule rods inside and out.

8. The method of claim 7, wherein the plurality of carbon fiber tubule rods each further comprises at least one side hole exposed along the outer surface.

9. The method of claim 7, wherein the plurality of carbon fiber tubule rods each are made from braided carbon fiber tow.

10. The method of claim 7, wherein the plurality of carbon fiber tubule rods each are printed on a 3-D carbon fiber printer.

11. The method of claim 7, wherein the plurality of carbon fiber tubule rods each have a corrugated shape.

12. The method of claim 7, wherein the plurality of carbon fiber tubule rods each further comprise a resin coating covering the outer surface and interior wall of the carbon fiber tubule rod.
